(19) United States
(12) Patent Application Publication
(10) Pub. No.: US 2018/0078025 A1
(43) Pub. Date: Mar. 22, 2018

(54) Michif cell phone bag

(71) Applicant: Joyce M. Weeks, Racine, WI (US)

(72) Inventor: Joyce M. Weeks, Racine, WI (US)

(21) Appl. No.: 15/330,441

(22) Filed: Sep. 22, 2016

(51) Int. Cl. A45F 5/02; H04B 1/3888; H04B 1/3827

(52) U.S. Cl. CPC A45F 5/021; A45F 2005/008; H04B 1/385; H04B 1/3888

(57) ABSTRACT

A cell phone bag with a slim profile having a first side, a second side and an interior portion. The first and second sides are made of leather and include stitching to keep them in contact with each other. The interior portion of the bag includes at least two pockets for holding a cell phone. The bag also includes two straps for securing the bag to a user.

### CROSS REFERENCE TO RELATED APPLICATION

This application claims the benefit of U.S. Provisional Application No. 62/125,632 filed on Jan. 28, 2015, the contents of which are incorporated by reference herein in its entirety.

### FIELD

This application relates to bags and, more particularly, to a bag adapted to hold a cell phone.

### BACKGROUND

Handbags are utilized for a variety of reasons. In most cases to hold items particular to a specific user. This invention is drawn to a specific bag to hold a cell phone.

A wide variety of bags have been created and are available. However, there is a need for improvement in a bag to carry a cell phone, and it is to this need that this device is directed. This device overcomes certain problems and shortcomings in the prior art by namely providing an improved cell phone bag.

### SUMMARY

In accordance with the present device, a cell phone bag with a slim profile comprising a first side, a second side and an interior portion. It is highly preferred that the first and second sides are made of leather and including stitching therebetween to keep them in contact with each other. It is also highly preferred that the interior portion includes at least two pockets for holding a cell phone and that the bag also includes two straps for securing the bag to a user's pants using the belt loops on such pants. Preferably, different embellishments in a variety of forms can be added to the bag for decorative purposes.

### BRIEF DESCRIPTION OF THE DRAWINGS

FIG. 1 is a front perspective view of a cell phone bag;

FIG. 2 is a rear perspective view of the cell phone bag of FIG. 1;

FIG. 3 is a front view of the cell phone bag of FIG. 1; and

FIG. 4 is a rear view of the cell phone bag of FIG. 1.

### DETAILED DESCRIPTION OF PREFERRED EMBODIMENTS

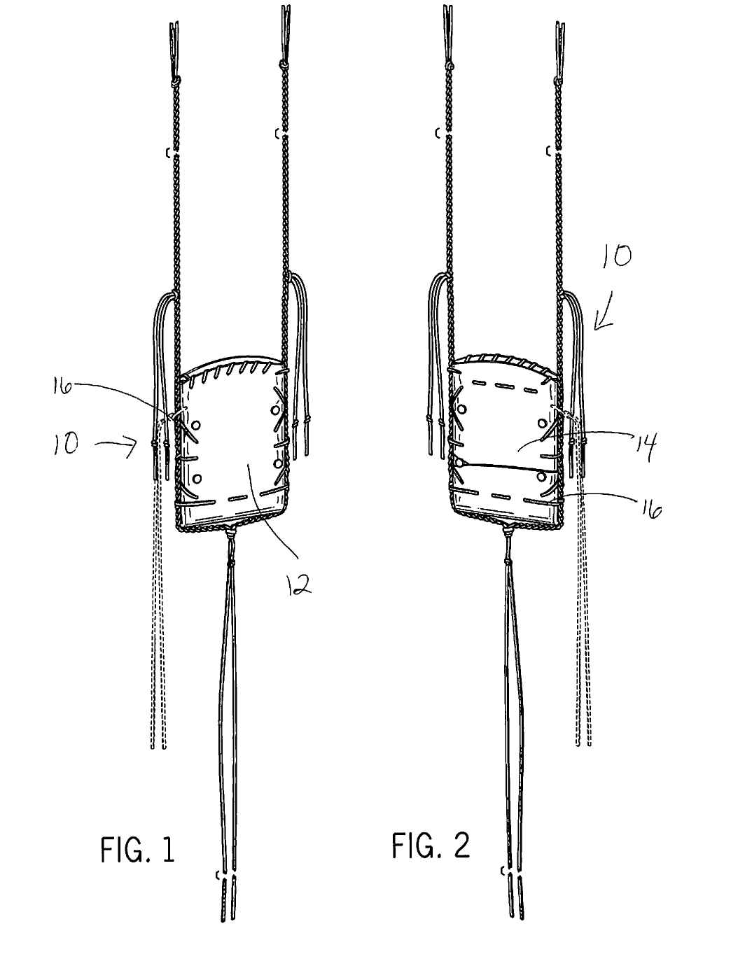

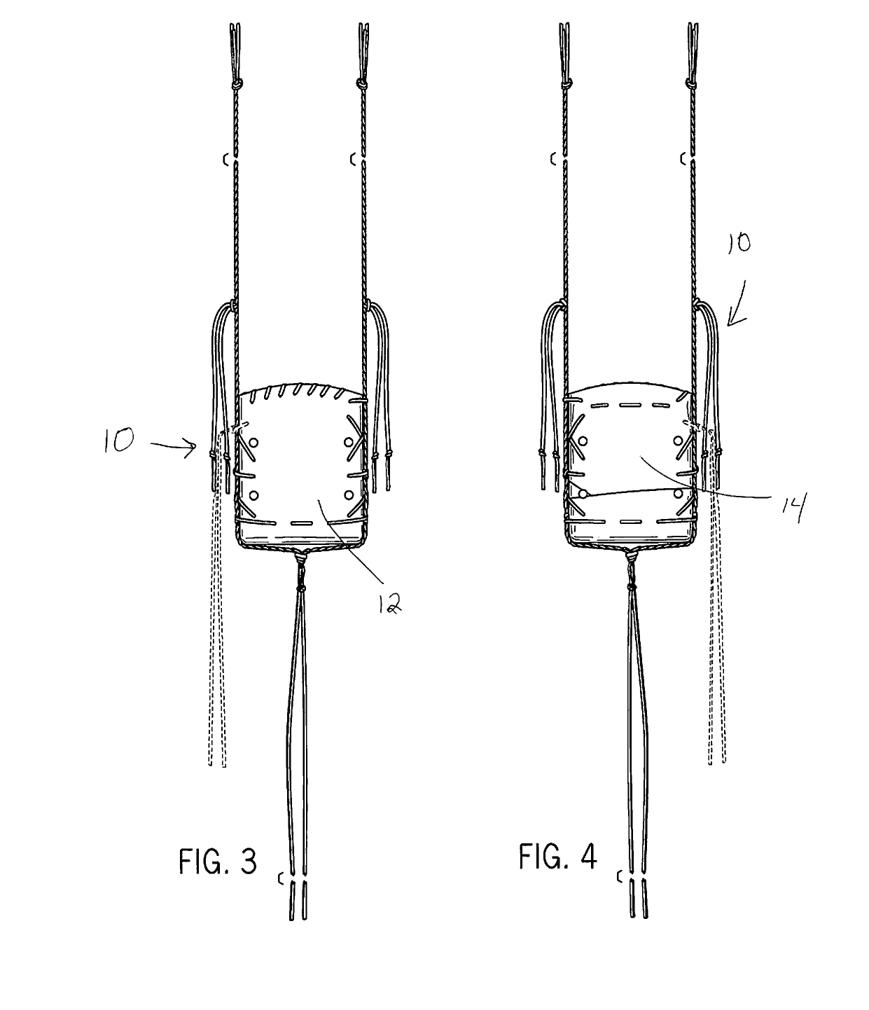

FIGS. 1-4 illustrate an inventive cell phone bag 10. Bag 10 is made of a 12″×12″ circle of leather. Two sides of the circle are folded toward the middle and sewn together to create a 6″×4¼″ rectangle and this also creates a pocket at each end.

The rectangle is folded in half. Both sides 12, 14 are held together with clips and then ⅛^{th} inch holes are formed down each side of the bag. Four holes are formed across the bottom, six holes across the top front of the bag and seven holes across the top back side.

One ten-foot suede strip is laced (shoelace style) 16 through the holes formed in the bag starting at the top right side and continuing through the bottom and up the left side. Both strips end up on the top left outside of the bag when this step is completed. The front suede strip is then inserted through the six holes that are on the front of the bag and wraps around the bag and is inserted through the last hole on the top back side of the bag and ends up inside the back of the bag. That strip end is then tied into a slip knot. The back suede strip is inserted through the remaining six holes on the back of the bag and also ends up inside the back of the bag. That strip end is tied into a sheet bend knot and secured through the slip knot.

Next one ten-foot suede strip is tied (using a lark head knot) to the middle of three ten-foot suede strips. The three strips on each side are then braided. This creates two braided strips on top and two unbraided strips on the bottom. Starting at the bottom of the bag the braids are then inserted (in and out) through the lacings on each side and come up past the top of the bag and measure fourteen inches on each side. The ends of each braid are tied (but not together) with a figure-eight knot. A twelve-inch suede strip is then tied (using a larks head knot) into the middle of each fourteen-inch braid on top, and thus, creates two six-inch strips protruding out of each middle braid. These braids then become the handles which the user attaches to the belt loops on their pants.

Only two belt loops are needed for bags to be worn. Each fourteen-inch top braid is put through one side by side belt loop on waist band of pants and comes down to form two braids and is tied together with the six-inch strip on both sides. The two unbraided suede strips that were tied to the middle of the braids end up on the bottom of the bag. These two strips are then wrapped around the user's thigh holster style and tied in place. This is how the bag is secured and worn.

Different sizes of suede strips are used to tie the lacings and braids together on each side for added stability. Embellishments are then added for decoration such as jewelry, studs and beads. Velcro® strips can be used to hold the bag closed.

While the principles of this invention have been described in connection with specific embodiments, it should be understood clearly that these descriptions are made only by way of example and are not intended to limit the scope of the invention.

1. A cell phone bag with a slim profile comprising a first side, a second side and an interior portion, the first and second sides comprised of leather and including stitching therebetween to keep them in contact, the interior portion including at least two pockets for holding a cell phone, the bag also including two straps for securing the bag to a user.
